(19) United States
(12) Patent Application Publication
(10) Pub. No.: US 2006/0107780 A1
(43) Pub. Date: May 25, 2006

(54) Gear shifter pen assembly

(76) Inventors: Bradley S. Beiermann, Crystal Lake, IL (US); Dianne M. Beiermann, Crystal Lake, IL (US)

Correspondence Address: MERONI + MERONI, P.O. BOX 309, BARRINGTON, IL, 60011, US

(21) Appl. No.: 10/470,662

(22) Filed: Nov. 23, 2004

(51) Int. Cl. G05G 1/04

(52) U.S. Cl. 74/523

(57) ABSTRACT

A gear shifter pen assembly comprises an upper assembly and a lower assembly. The upper assembly comprises a cartridge-receiving shaft housing and a writing element. The writing element is received in the shaft housing. The lower assembly comprises an inner junction assembly and an outer base assembly. The base assembly comprises a junction-concealing boot and a platform assembly. The junction assembly comprises a universal joint, a shifter-receiving seat, and boot support structure. The boot support structure supports the superior end of the boot and the inferior end of the boot engages the platform assembly, the boot thus concealing the junction assembly. The lower assembly thus holds the upper assembly when the shifter-receiving seat removably receives the upper assembly and the writing element enables a user to write when the upper assembly is removed from the shifter-receiving seat. Further, the universal joint allows the user to selectively position the upper assembly.

### FIELD OF THE INVENTION

The present invention generally relates to a novel pen and pen holder combination. More particularly, the present invention relates to pen and pen holder assembly formed to resemble a vehicular manual transmission gear shifter or gear selector.

### DESCRIPTION OF THE PRIOR ART

It is noted that vehicle enthusiasts frequently desire obtaining commonly-sued, everyday items (such as writing utensils) formed to resemble vehicular parts as a means to indicate to passersby their vehicular enthusiasm. In this regard, it is contemplated that the prior art perceives a need for a gear shifter pen assembly, as the general structure of a manual transmission gear shifter lends itself well to a pen and pen holder design. Notably, the prior art is replete with examples of various ornamental designs for pen and pen holding apparatus. Some of the more pertinent ornamental combination pen and pen holder designs may be seen from a review or general inspection of U.S. Design Pat. Nos. D35,466; D146,064; D147,439; D155,152; D160,030; D165,852; D212,836; D226,337; D254,083; D279,481; D314,793; D336,658; D352,962; D447,172; D482,394; and D483,069. In addition to some of the more pertinent ornamental designs for pen and pen holder assemblies, the prior art teaches various utilitarian combination pen and pen holder systems and assemblies. Some of the more pertinent utility type prior art relating to pen holding assemblies and the like is described hereinafter.

U.S. Pat. No. 6,167,596 ('596 patent), which issued to Berman, discloses a Secured Pen and Holder. The '596 patent teaches a pen and pen holder arrangement that provides security for retaining the pen in which no tools are required to replace a used up pen. A pen with a flexible tether that terminates in a ball is employed together with a holder that receives the ball. The holder has a base with an opening adequate to pass the ball through and a transport that rotates within the base so that the ball can be moved from an insertion state to a holding state. In the holding state, the track has a dimension that holds the ball within the holder. A rotatable base cover that rotates with the transport obscures the transport from view and has a longitudinal slot opening enlarged at one end to permit the ball to be passed into the holder and otherwise a slot to permit the tether to move with the ball into the holding state.

U.S. Pat. No. 6,735,825 ('825 patent), which issued to Berman et al., discloses a Secured Pen and Holder. The '825 patent teaches a pen and pen holder system, wherein the pen holder has a base sidewall sandwiched between a cover sidewall and a transport sidewall. The cover and transport are rotatable relative to the base between a pen replacement state and a pen use state. The pen is coupled to the pen holder by a tether and a stop. Certain improvements over the '596 patent comprise a cover engagement member on the inner surface of the cover, first and second base engagement members on the base, the cover engagement member and the first base engagement member resiliently engage each other when the pen holder is in the replacement state. The cover engagement member and the second base engagement member resiliently engage each other when the pen holder is in the use state. A transport engagement member on the transport, a third base engagement member on the base, said The transport engagement member and the third base engagement member resiliently engage each other when the pen holder is in the use state to position a wall of the transport adjacent to the stop of the pen in the use state thereby preventing inward movement of the tether of the pen in the use state.

U.S. Pat. No. 6,575,649 ('649 patent), which issued to Kuan-Hsiung et al., discloses a Pen Holder. The '649 patent teaches an extendable elastic cord fastened with one writing instrument which connects with a base of the pen holder for users of the pen to write or take notes by drawing the pen out of the holder and the pen never separates from the base of the pen holder. The pen holder comprises a base which includes a left cover and a right cover, an automatic coil apparatus and a detent device. The automatic coil apparatus as described in the '649 patent consists of a bearing tube, a tube lid, a spiral spring, a winding wheel and a binding cord. The detent device of the invention includes a rubbing plate, a leaf spring, a detent rod and a spring. The automatic coil apparatus and the detent device are installed inside the body of the left cover and right cover to integrate as a whole. When the writing instrument is not utilized or after utilization, it is inserted in the base of the invention that enables the binding cord to be automatically coiled, under the control of the detent device, into the winding wheel of the bearing tube so that the cord will not hang loose outside the pen holder.

U.S. Pat. No. 4,984,379 ('379 patent), which issued to Lee, discloses a Pen Structure with a Flag. The '379 patent teaches a writing instrument having a display flag attached to an internal pen holder such that the flag may be displayed either by pulling it laterally through any elongated opening in an external pen holder, or by axially extending the internal pen holder from the external pen holder. A positioning block attached to the internal pen holder limits the relatively axial sliding movement between the internal and external pen holders to prevent the user from completely pulling the internal pen holder from the external pen holder. The writing instrument may also be placed in a base such that the flag may be displayed while the base rests on a desk, table, or the like.

From an inspection of these patent disclosures and other art generally known in the relevant art, it will be seen that the prior art does not teach a novelty pen and pen holder combination that is formed to resemble and operate in a manner that is reflective of a vehicular manual transmission gear shifter. Thus, the prior art perceives a need for a gear shifter pen assembly or combination pen and pen holder that resembles a manual transmission gear shifter as summarized below.

### SUMMARY OF THE INVENTION

It is thus a primary object of the present invention to provide a novelty pen and pen holder combination designed with automotive enthusiasts in mind. In this regard, it is an object of the present invention to provide a combination pen and pen holder that resembles an automotive or vehicular gear selector or gear shifter assemblage. It is a further object to provide a pen and pen holder combination so that when the writing element or pen portion is stowed, the writing element portion may be manipulated in much the same manner as a gear shifter. When removed from a stowed position, the writing element may be utilized to compose writings as the user may elect.

To achieve these and other readily apparent objectives, the present invention essentially provides a gear shifter pen assembly, the gear shifter pen assembly comprising, in combination, an upper pen-shifter assembly and a lower pen-holding boot assembly. The upper pen-shifter assembly essentially comprises a cartridge-receiving shaft housing and a writing element. The shaft housing essentially comprises a superior housing end, an inferior housing end, a shifter-simulative outer shaft surface, and an element-receiving inner shaft surface. The writing element essentially comprises an ink outlet and an ink-retaining body. The ink-retaining body is received in the shaft housing in medial adjacency to the inner shaft surface. The ink outlet extends from the inner shaft surface to the outer shaft surface adjacent the inferior housing end.

The lower pen-holding boot assembly essentially comprises an inner junction assembly and an outer base assembly. The outer base assembly essentially comprises a junction-concealing boot and a platform assembly. The inner junction assembly essentially comprises element-receiving means and boot support means. The element-receiving means essentially comprises a superior shifter-receiving end and an inferior platform-engaging end. The inferior platform-engaging end is fixedly attached to the platform assembly. The boot support means are cooperatively associated with the element-receiving means intermediate the superior shifter-receiving end and the inferior platform-engaging end. The junction-concealing boot comprises a superior boot end, an inferior boot end, an inner boot surface, and an outer boot surface. The superior boot end comprises an end-receiving aperture. The boot support means support the superior boot end and the superior shifter-receiving end extends from the inner boot surface to the outer boot surface through the end-receiving aperture.

The platform assembly comprises a support platform having a superior platform surface and an inferior platform surface. The inferior platform surface is positionable in superior adjacency to a pen assembly-supporting surface. The inferior housing end is removably received by the superior shifter-receiving end. The lower pen-holding boot assembly holds the upper pen-shifter assembly when the superior shifter-receiving end removably receives the inferior housing end. The ink outlet enables a user to write when the inferior housing end is removed from the superior shifter-receiving end.

Other objects of the present invention, as well as particular features, elements, and advantages thereof, will be elucidated in, or apparent from, the following description and the accompanying drawing figures.

### BRIEF DESCRIPTION OF THE DRAWINGS

Other features of our invention will become more evident from a consideration of the following brief description of patent drawings, as follows:

FIG. 1 is a cross-sectional side view of the preferred embodiment of the gear shifter pen assembly showing an upper pen-shifter assembly and a lower pen-holding boot assembly with a first boot support assembly.

FIG. 2 is a cross-sectional side view of the upper pen-shifter assembly as depicted in FIG. 1.

FIG. 3 is a side plan view of the preferred embodiment of the gear shifter pen assembly showing the upper pen-shifter assembly and a first outer base assembly.

FIG. 4 is a perspective view of the preferred embodiment of the gear shifter pen assembly showing the upper pen-shifter assembly removably received in a superior shifter-receiving end.

FIG. 5 is a perspective view of the preferred embodiment of the gear shifter pen assembly with the upper pen-shifter assembly removed from the superior shifter-receiving end.

FIG. 6 is side plan view of the inner junction assembly attached to a superior platform surface of a support platform with a cross-sectional view through a portion of the support platform.

FIG. 7 is a perspective view of the inner junction assembly attached to the superior platform surface of the platform assembly with the first boot support assembly removed.

FIG. 8 is a top plan view of a boot support washer component of the first boot support assembly.

FIG. 8(a) is an edge view of the boot support washer as depicted in FIG. 8.

FIG. 9 is a cross-sectional side view of a first alternative embodiment of the gear shifter pen assembly showing the upper pen-shifter assembly and the lower pen-holding boot assembly with a second boot support assembly.

FIG. 10 is a perspective view of the first alternative embodiment of the gear shifter pen assembly showing the upper pen-shifter assembly and a second outer base assembly.

FIG. 11 is a fragmentary perspective view of the first alternative embodiment of the gear shifter pen assembly showing the inferior housing end of the upper pen-shifter assembly, the inner junction assembly attached to the support platform, and the second boot support assembly.

FIG. 12 is a top plan view of a second alternative embodiment of the gear shifter pen assembly showing an optional plurality of utility trays cooperatively associated with the support platform.

FIG. 13 is a side plan view of the second alternative embodiment of the gear shifter pen assembly depicted in FIG. 12 with a cross-sectional view through a portion of the support platform.

FIG. 14 is a perspective view of a third alternative embodiment of the gear shifter pen assembly showing optional dashboard visual effect gadgetry cooperatively associated with the support platform.

### DETAILED DESCRIPTION OF THE PREFERRED EMBODIMENT

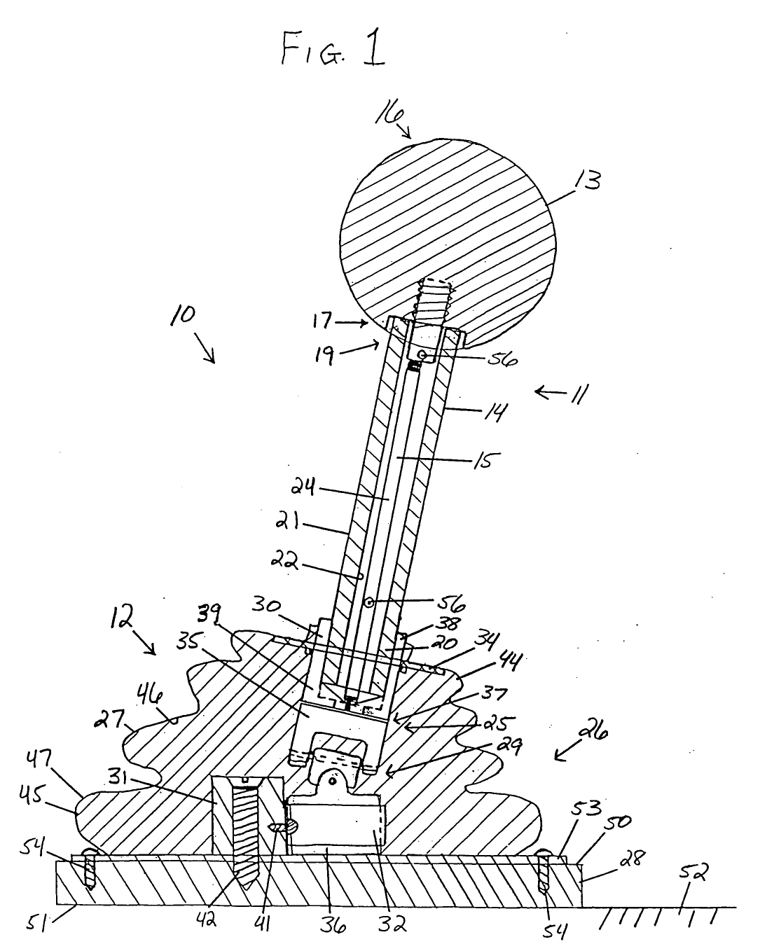

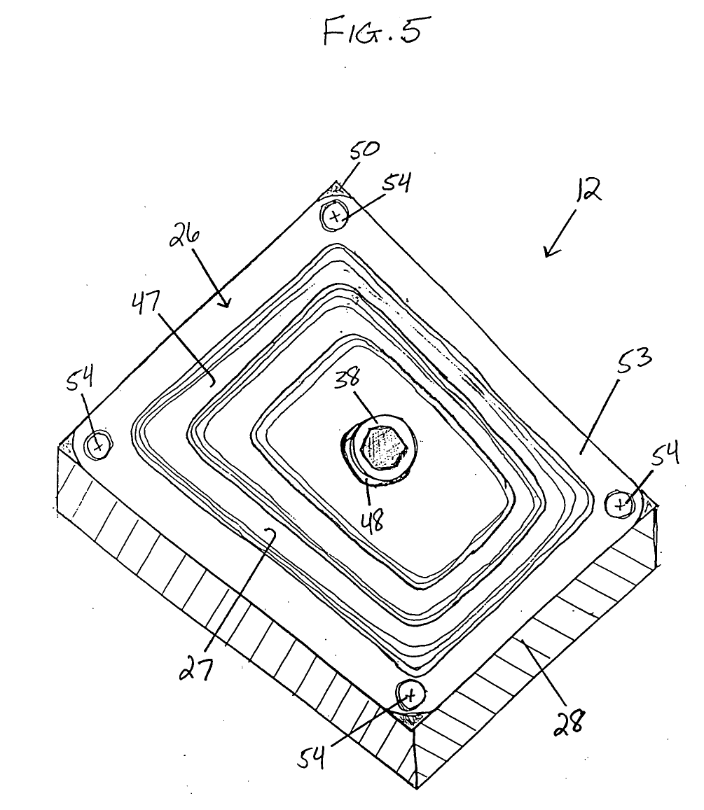

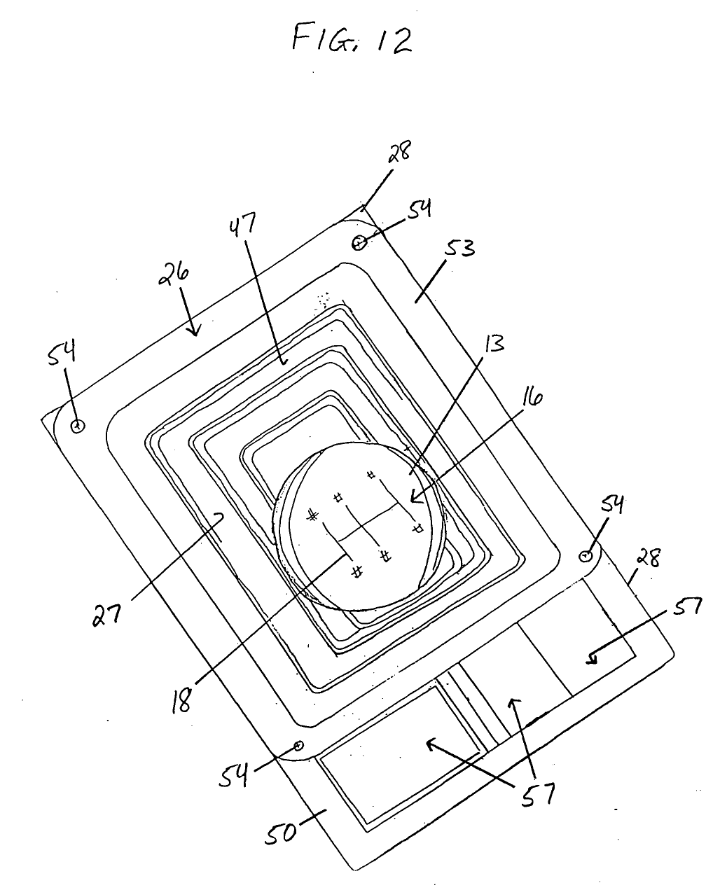

Referring now to the drawings, the preferred embodiment of the present invention generally concerns a combination pen and pen-holding assembly that is formed to resemble a traditional gear shifter or gear selector type assemblage. Thus, the present invention discloses a gear shifter pen assembly 10 as illustrated and generally referenced in FIGS. 1, 3, and 4. Gear shifter pen assembly 10 preferably comprises, in combination, an upper pen-shifter assembly 11 as illustrated and referenced in FIGS. 1, 2, 3, 10, 13, and 14; and a lower pen-holding boot assembly 12 as illustrated and referenced in FIGS. 1, and 3-5. Upper pen-shifter assembly 11 preferably comprises a shifter knob or handle 13 as illustrated and referenced in FIGS. 1-4, 9, 10, and 12-14; a cartridge-receiving shaft housing 14 as illustrated and referenced in FIGS. 1, 2, 3, 9, 11, 13, and 14; a writing element 15 as illustrated and referenced in FIGS. 1, 2, and 9; and cartridge-setting means. The cartridge-setting means may preferably be defined by a plurality of set screws 56 as illustrated in FIGS. 12, which are designed to prevent movement of ink-retaining body 24 within (or relative to) cartridge-receiving shaft housing 14. Other cartridge-setting means that may be used to prevent movement of ink-retaining body 24 within (or relative to) cartridge-receiving shaft housing 14 may include threaded screw tips.

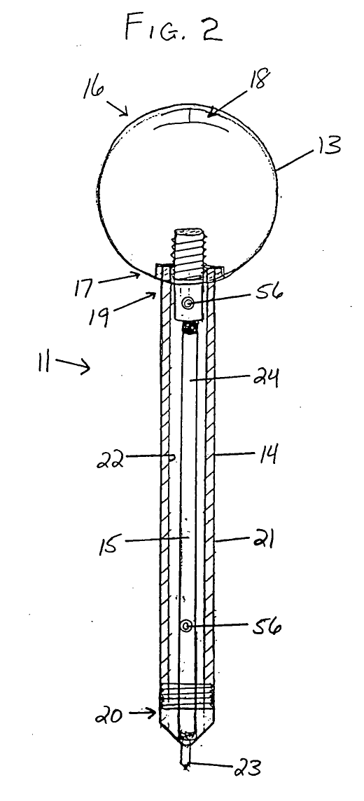

Notably, shifter knob 13 may embody any one of many types of shifter knobs available in the art. For ease of illustration, shifter knob 13 has been illustrated in the noted figures as a generic ball-type shifter. It is contemplated that shifter knob 13 may embody any style shifter knob, or handle, as per the election of the consumer or user so long as shifter knob preferably comprises a superior hand-receiving surface 16 or hand-engaging surface as illustrated and referenced in FIGS. 1, 2, 4, 9, 10, and 12-14; and an inferior shaft-engaging region 17 as illustrated and referenced in FIGS. 1, 2, 3, 9, 10, 13, and 14. It will be seen from a general inspection of FIGS. 2, 4, and 12 that hand-receiving surface 16 may comprise indicia as referenced at 18 for enhancing the overall visual effect of shifter knob 13. It is contemplated that inferior shaft-engaging region 17 of shifter knob 13 may either comprise male engagement structure or female engagement structure for attachment to shaft housing 14. Accordingly, shaft housing 14 preferably comprises corresponding female engagement structure or male engagement structure for receiving or otherwise engaging shifter knob 13.

Cartridge-receiving shaft housing 14 preferably comprises a superior housing end or superior knob-engaging end 19 as illustrated and referenced in FIGS. 1, 2, 3, and 9; an inferior housing end or inferior socket-engaging end 20 as illustrated and referenced in FIGS. 1, 2, 9, and 11; a shifter-simulative outer shaft surface 21 as illustrated and referenced in FIGS. 1-4; and an element-receiving inner shaft surface 22 as illustrated and referenced in FIGS. 1, 2, and 9. It will be noted that outer shaft surface 21 has been described with the term, “shifter simulative”. Since it is contemplated that various other components of the present invention, when in a disassembled state, readily resemble components of a traditional gear shifter assemblage, shaft housing 14, when in a disassembled state, may not readily resemble a component of a traditional gear shifter assemblage. Outer shaft surface 21 is thus designated as “shifter-simulative” so as to reflect the need to otherwise describe structure that is generally cylindrical in nature. Cylindrically-shaped structures are frequently included in the design of mechanical devices and thus it is believed that a “shifter-simulative” outer shaft surface 21 more properly defines the subject matter of the present invention.

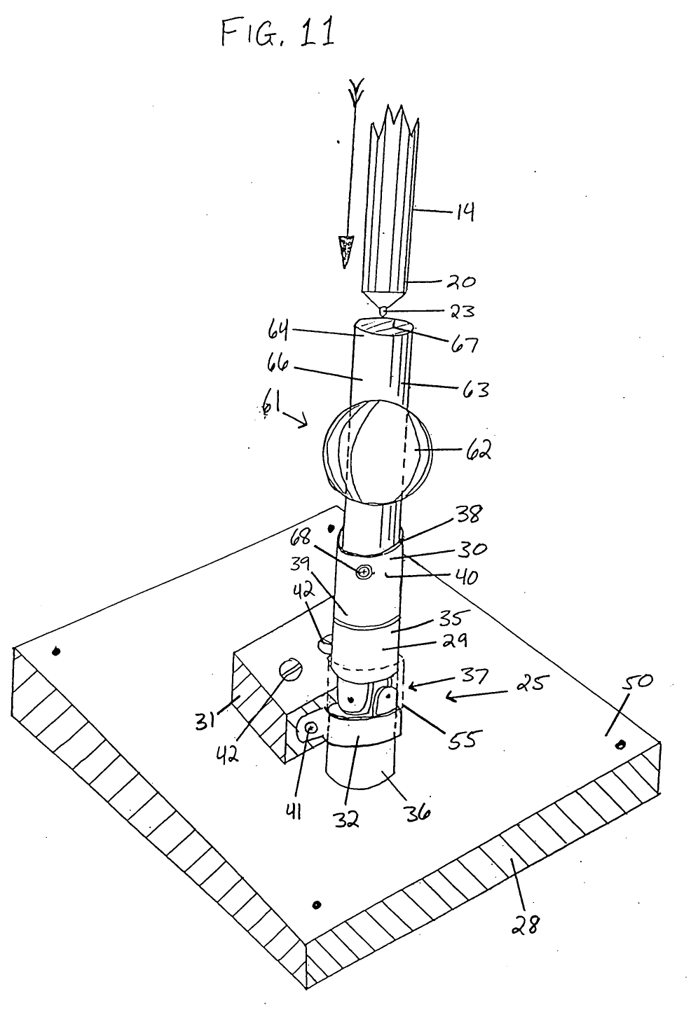

Writing element 15 preferably comprises an ink outlet 23 as illustrated and referenced in FIGS. 2 and 11; and an ink-retaining body 24 or ink cartridge as illustrated and referenced in FIGS. 1, 2, and 9. Ink-retaining body 24 is preferably received in cartridge-receiving shaft housing 14 in medial adjacency to inner shaft surface 22. In other words, ink-retaining body 24 is insertable into cartridge-receiving shaft housing 14 such that ink-retaining body 24 is radially inward of inner shaft surface 22, inner shaft surface 22 preferably having a circular lateral cross section. It will be noted from an inspection of the noted figures that ink outlet 23 preferably extends from inner shaft surface 22 to outer shaft surface 21 adjacent the inferior socket-engaging end or inferior housing end. It is contemplated that this type of structural configurations is common to the art of writing implements and thus well within the ordinary skill of those in the art and hence no further descriptions thereof are necessary. As earlier specified, inferior shaft-engaging region 17 is preferably removably attached to superior knob-engaging end 19 via a cooperative male-female coupling.

Lower pen-holding boot assembly 11 preferably comprises an inner junction assembly 25 as illustrated and referenced in FIGS. 1, 6, 7, 9, and 11; and an outer base assembly 26 as illustrated and referenced in FIGS. 1, 3-5, 9, 10, and 12-14. Outer base assembly 26 preferably comprises a flexible junction-concealing boot 27 as illustrated and referenced in FIGS. 1, 3-5, 9, 10, and 12-14; and a platform assembly 28 as illustrated and referenced in FIGS. 1, 3-7, and 9-14. The present invention thus contemplates that the basal portions of the gear shifter pen assembly comprises structure resembling an automotive transmission shifter boot. Junction-concealing boot 27 can be formed in various shapes and sizes as can shifter knob 13. For ease of illustration, generic type shifter boots have been depicted in the noted figures. However, it is contemplated that other shifter boot shapes may include parallelepiped, spherical, ellipsoidal, conical, and pyramidal-type three-dimensional shapes. Further, junction-concealing boot 27 is preferably formed from a flexible material, such as rubber, leather, cloth fabric, etcetera.

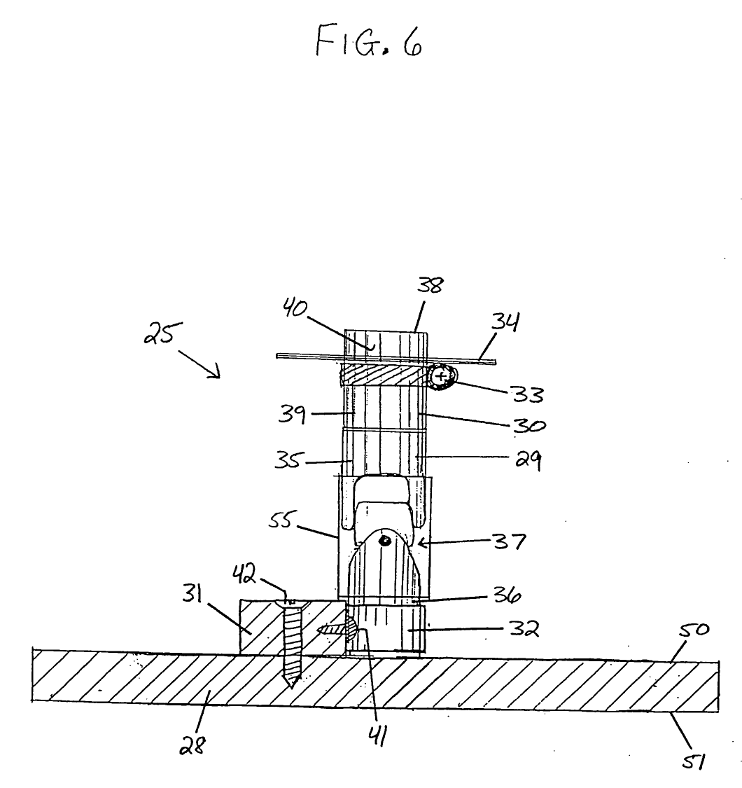

Inner junction assembly 25 preferably comprises a universal joint 29 as illustrated and referenced in FIGS. 1, 6, 7, 9, and 11; an element-receiving socket 30 as illustrated and referenced in FIGS. 1, 6, 7, 9, and 11; a universal mount 31 as illustrated and referenced in FIGS. 1, 6, 7, 9, and 11; a universal clamp 32 as illustrated and referenced in FIGS. 1, 6, 7, 9, and 11; a washer support clamp 33 as illustrated and referenced in FIG. 6; a boot support washer 34 as illustrated and referenced in FIGS. 1, 6, 8 and 8(a); and movement-restricting means. It is contemplated that the movement restricting means may be cooperatively associated with universal joint 29 for restricting movement thereof. In this regard, it is further contemplated that movement-restricting means may preferably be defined by a mechanical movement restrictor that can be used with universal joint 29 to restrict the shifter boot movement. It is contemplated that the mechanical movement restrictor may be constructed from a coil type spring, a length of rubber hose, or wire ties. It is thus contemplated that the movement-restricting means may be defined by a joint-surrounding sleeve; the joint-surrounding sleeve generally surrounding certain triaxial orientation means as referenced at 37. Notably, the joint-surrounding sleeve comprises some degree of positionable flexibility, the positionable flexibility for enhancing the selective positionability of upper pen-shifter assembly 11. The movement restricting means has been referenced at 55 in FIGS. 6, 7, and 11.

Universal joint 29 preferably comprises a superior socket-engaging end 35, an inferior mount end 36, and triaxial orientation means 37 as generally illustrated and referenced in FIGS. 1, 6, 7, 9, and 11. It will be seen from an inspection of the noted figures, that the triaxial orientation means 37 are preferably spatially located intermediate superior socket-engaging end 35 and inferior mount end 36. It is noted that universal joints are commonly used to enable users to selectively and triaxially orient structure attached to the universal joint. In this regard, universal joint 29 is included in the design of the present invention so that users thereof may selectively position upper pen-shifter assembly 1 in much the same way that an actual manual transmission gear shifter assemblage operates. In the preferred embodiment, universal joint 29 functions to enable certain movement within the shifter boot. It is contemplated that other mechanical mechanisms (other than universal joint 29) could also be used to enable movement within the shifter boot such as a coil spring, a length of rubber hose, a semi-sphere, and the like.

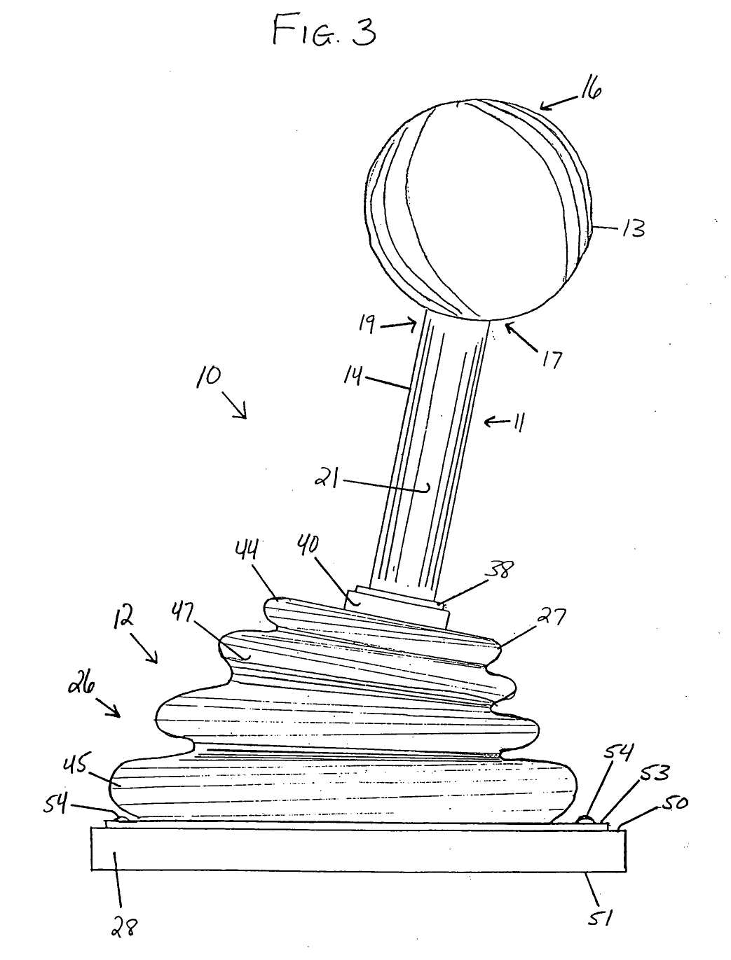

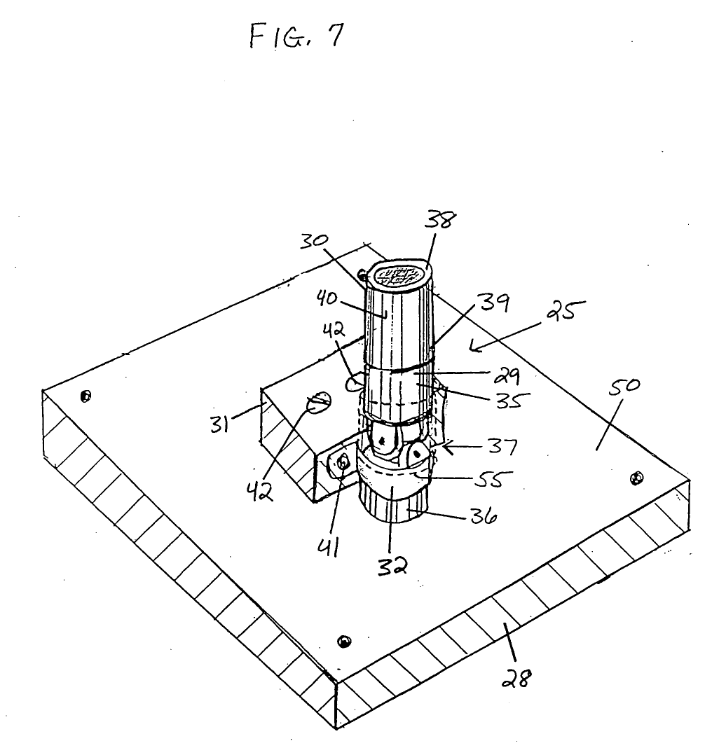

Element-receiving socket 30 preferably comprises a superior shifter-receiving end 38 as illustrated and referenced in FIGS. 1, 4-6, 9, 11, 13, and 14; an inferior joint-engaging end 39 as illustrated and referenced in FIGS. 1, 6, 7, 9, and 11; and an outer socket surface 40 as generally illustrated and referenced in FIGS. 3, 6, 7, 11, and 13. Element-receiving socket 30 may thus define certain element-receiving means of the present invention. As will be understood from an inspection of the noted figures, inferior joint-engaging end 39 is preferably fixedly attached to superior socket-engaging end 35. Further, it will be understood that universal clamp 32 preferably functions to mount inferior mount end 36 to universal mount 31. Preferably, fastening means along with universal clamp 32 function to mount inferior mount end 36 to universal mount 31. It is contemplated that the fastening means may be defined by at least one clamp screw 41 as illustrated and referenced in FIGS. 6, 7, 9, and 11. Universal mount 31 is thus preferably fixedly attached to platform assembly 28 via fastening means. The fastening means preferably used to fixedly attach universal mount 31 to platform assembly 28 may preferably be defined by at least one mount screw 42 as illustrated and referenced in FIGS. 1, 6, 7, 9, and 11. As illustrated in FIGS. 7 and 11, two mount screws fasten universal mount 31 to platform assembly 28.

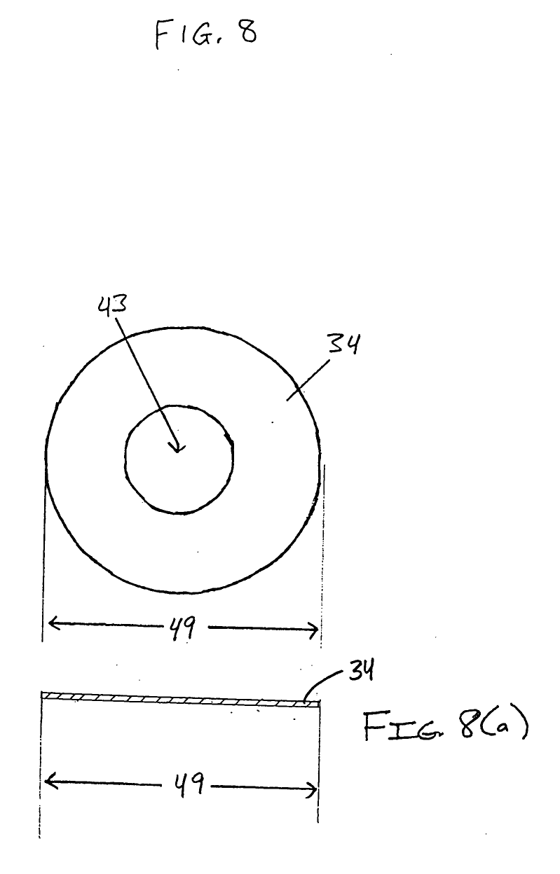

Washer support clamp 33 is preferably mounted in radial adjacency to outer socket surface 40 intermediate superior shifter-receiving end 38 and inferior joint-engaging end 39. From an inspection of FIG. 8, it will be seen that boot support washer 34 comprises a circular socket-receiving aperture as referenced at 43. Socket-receiving aperture 43 is sized to receive element-receiving socket 30 as generally shown in FIGS. 1 and 6. It will be further seen from an inspection of FIG. 8 that boot support washer 34 comprises an inner washer diameter (at aperture 43) and an outer washer diameter. The outer washer diameter has been referenced at 49 in FIGS. 8 and 8(a). From an inspection of FIG. 6, it will be further seen that washer support clamp 33 functions to support boot support washer 34 intermediate superior shifter-receiving end 38 and inferior joint-engaging end 39.

Thus, it will be seen that washer support clamp 33 and boot support washer 34 together form a cooperative washer support assembly, which washer support assembly defines certain boot support means. Thus, certain boot support means of the present invention may be defined by the washer support assembly, which assembly comprises washer support clamp 33 and boot support washer 34. As previously specified, washer support clamp 33 is preferably mounted in circumferential relation to outer socket surface 40 intermediate superior shifter-receiving end 38 and inferior joint-engaging end 39. Boot support washer 34 comprises socket-receiving aperture 43, which aperture 43 receives the element-receiving means. Washer support clamp 33 thus supports boot support washer 34 and boot support washer 34 is thus preferably also positioned intermediate superior shifter-receiving end 38 and inferior joint-engaging end 39 for supporting superior boot end 44 in an elevated state relative to inferior boot end 45. Thus, the boot support means, as defined by the washer support assembly, is cooperatively associated with outer socket surface 40.

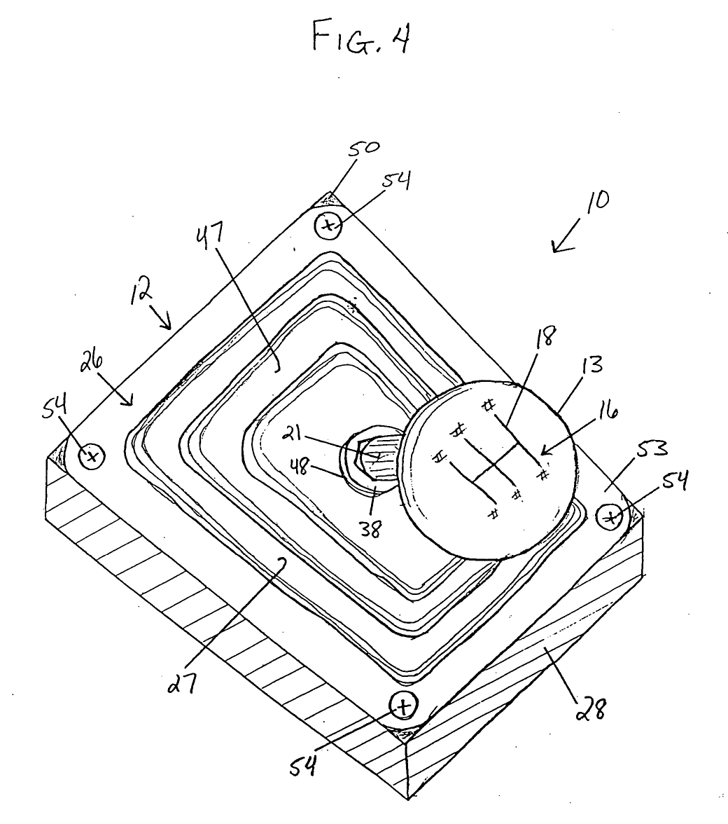

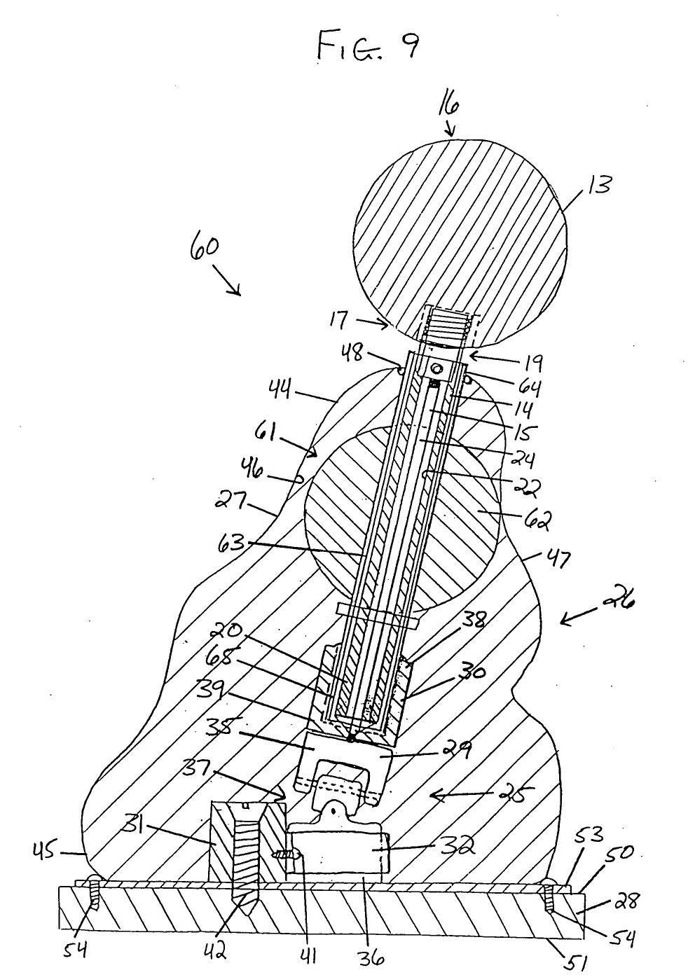

Junction-concealing boot 27 comprises a superior boot end 44 as illustrated and referenced in FIGS. 1, 3, 9, 10, 13, and 14; an inferior boot end 45 as illustrated and referenced in FIGS. 1, 3, 9, 10, 13, and 14; an inner boot surface 46 as illustrated and referenced in FIGS. 1 and 9; and an outer boot surface 47 as illustrated and referenced in FIGS. 1, 3-5, 9, 10, and 12-14. Superior boot end 44 preferably comprises a circular socket-receiving aperture as referenced at 48 in FIGS. 4, 5, 9, 10, and 14. Socket-receiving aperture 48 has a diameter of smaller magnitude than outer washer diameter 49. Thus, when socket-receiving aperture 48 receives element-receiving socket 30, outer washer diameter 49 prevents superior boot end 44 from collapsing from its otherwise elevated state. Thus, it will be seen that boot support washer 34 functions to support superior boot end 44 in an elevated position relative to inferior boot end 45 as may be seen from a general inspection of FIGS. 1, 3, 13, and 14. Superior shifter-receiving end 38 preferably extends from inner boot surface 46 to outer boot surface 47 through socket-receiving aperture 48.

The support platform of platform assembly 28 preferably comprises a superior platform surface 50 as illustrated and referenced in FIGS. 1, 3-7, and 9-14; an inferior platform surface 51 as illustrated and referenced in FIGS. 1, 3, 6, and 9; and a boot plate 53 as illustrated and referenced in FIGS. 1, 3-5, 9, 10, and 12-14. Boot plate 53 is preferably attached to superior platform surface 50 adjacent inferior boot end 45 via a plurality of boot fastening screws 54 as illustrated and referenced in FIGS. 1, 3-5, 9, 10, and 12-14. Boot plate 53 is preferably constructed from a decorative metal material, but could conceivably be constructed from wood, plastic, composite materials and the like. Inferior boot end 45 preferably engages superior platform surface 50 and inner boot surface 46 essentially defines a junction-assembly-receiving volume. In other words, the inner volume of junction-concealing boot 27 is of sufficient magnitude to cover and conceal junction assembly 25.

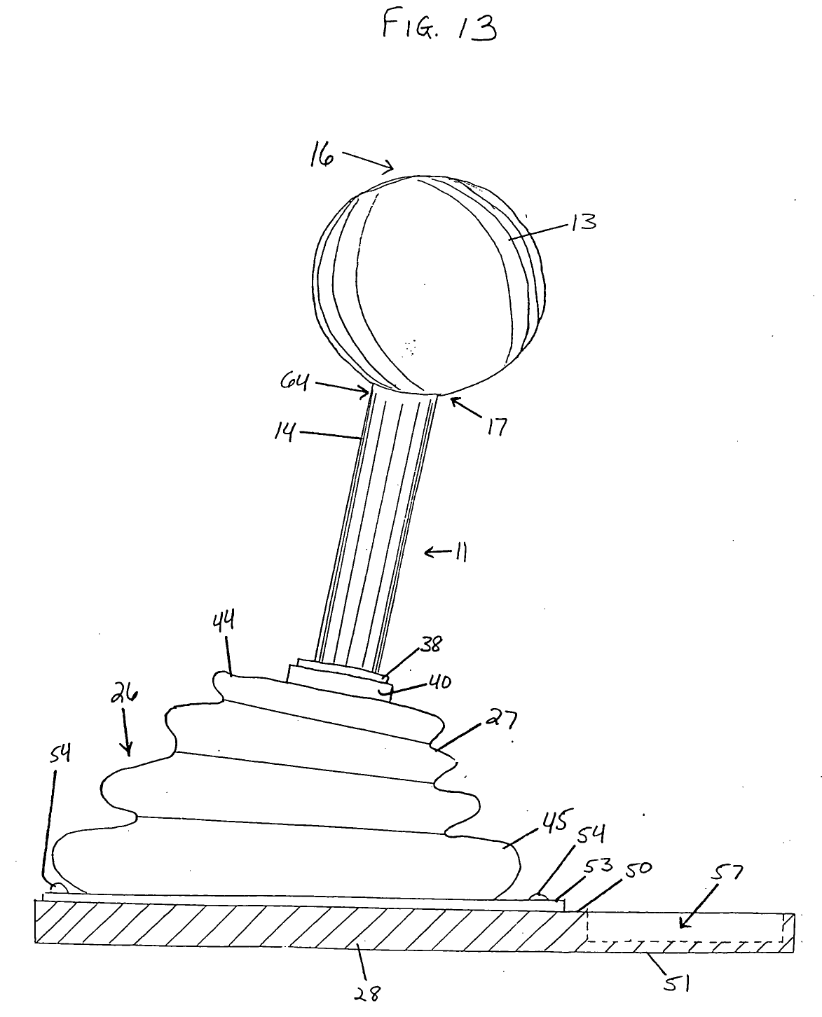

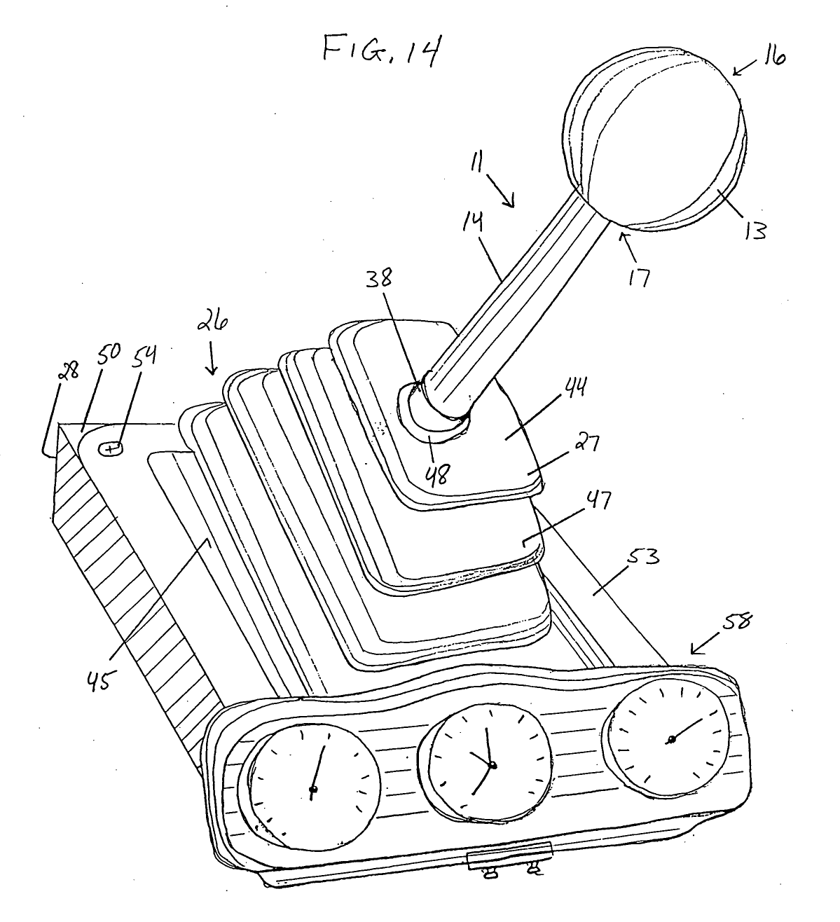

With further regard to platform assembly 28, it is contemplated that platform assembly 28 may comprise at least one utility tray as referenced at 57 in FIGS. 12 and 13. In this regard, it is contemplated that the utility tray(s) 57 may preferably be located adjacent superior platform surface 50 and function to enable the user to retain articles adjacent lower pen-holding boot assembly 12. Further, it is contemplated that platform assembly 28 may comprise dashboard visual effect gadgetry, or other vehicular visual effect gadgetry, as generally reference at 58 in FIG. 14. The dashboard visual effect gadgetry may comprise select dash panel accessories generally selected from the group comprising gauges, clocks, and the like. Notably, the gear shifter pen assembly is designed with automotive enthusiasts in mind. In this regard, it is contemplated that automotive enthusiasts may be desirous of obtaining a gear shifter pen assembly designed not only for its functionality as a pen and pen holder combination, but also as a novelty item. In this regard, it is contemplated that certain add-on automotive visual effects contribute to the overall appeal of the present invention. For example, it is contemplated that platform assembly 28 may comprise accessories such as dials, gauges, memo pads, engraving plaques, and the like.

Inferior platform surface 51 is preferably positionable in superior adjacency to a pen assembly-supporting surface as referenced at 52 in FIG. 1. In other words, platform assembly 28 may rest upon an assembly-supporting surface 52, the contact portion of platform assembly 28 being inferior platform surface 51. It is contemplated that the coefficient of friction between inferior platform surface 51 and assembly-supporting surface 52 may be insufficient to maintain gear shifter pen assembly 10 in a sedentary position when a user manipulates various features of the assembly. In this regard, it is contemplated that inferior platform surface 51 may comprise friction-enhancing means. In this regard, as an example, it is contemplated that inferior platform surface 51 may comprises a plurality of base-supporting feet (not specifically illustrated) as a means to help the platform remain stationary while upper pen-shifter assembly 11 is being moved. The base-supporting feet, may, for example, comprise suction means or adhesive means as means to decrease the likelihood of inferior platform surface 51 movement relative to assembly-supporting surface 52. In any event, it is contemplated that the base-supporting feet are designed to prevent movement of platform assembly 28 when the user selectively positions upper pen-shifter assembly 11.

Inferior socket-engaging end 20 is designed to be removably received in superior shifter-receiving end 38. It will be recalled that the triaxial orientation means 37 enables a user to selectively position upper pen-shifter assembly 11 when superior shifter-receiving end 38 removably receives inferior socket-engaging end 20. Conversely, ink outlet 23 enables the user to write (with upper pen-shifter assembly 11) when inferior socket-engaging end 20 is removed from superior shifter-receiving end 38.

### ALTERNATIVE EMBODIMENTS

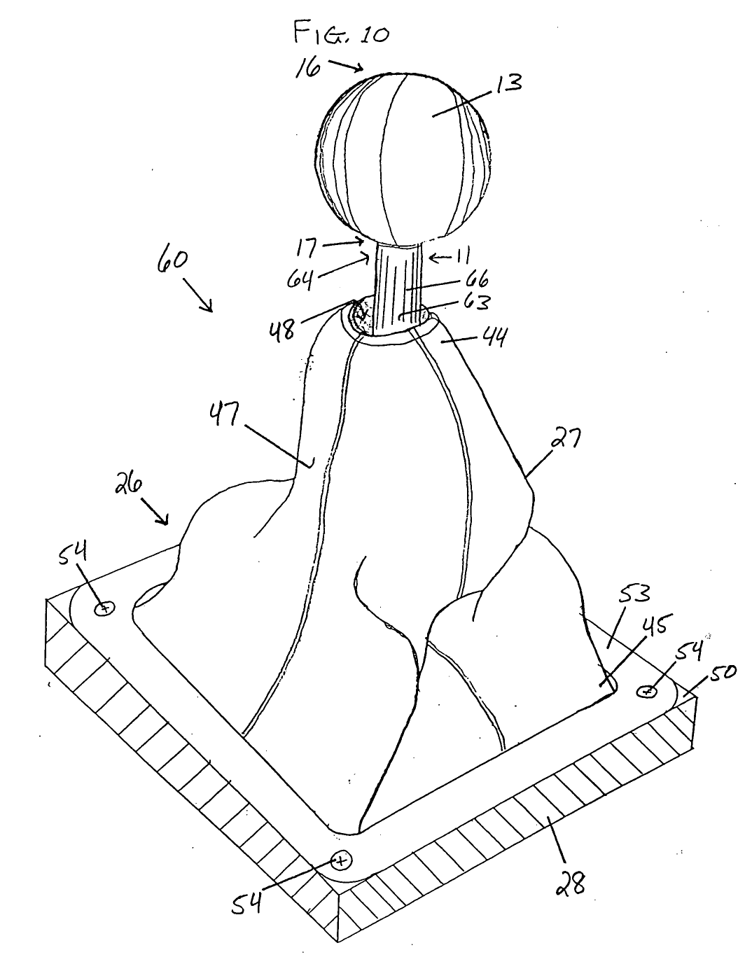

A first alternative embodiment of the present invention concerns a gear shifter pen assembly 60 as generally illustrated and referenced in FIGS. 9 and 10. Gear shifter pen assembly 60 is essentially identical to gear shifter pen assembly 10 save for certain structure relating to the boot support means. In this regard, gear shifter pen assembly 60 comprises a ball support assembly in place of a washer support assembly. Ball support assembly is generally referenced at 61 in FIGS. 9 and 11. It will be seen from an inspection of the noted figures that ball support assembly 61 preferably comprises a boot support sphere 62, which boot support sphere 62 comprises a superior sphere surface, a substantially vertical polar axis, a north pole, and a south pole. As is commonly understood, polar axes extend from a north pole to a south pole and represent lines or axes extending through the center of the sphere from a superior spherical region to an inferior spherical region. It is thus contemplated that the polar axis of boot support sphere 62 also extends from the north pole to the south pole of boot support sphere 62. From an inspection of the noted figures, it will be further seen that boot support sphere 62 is preferably fixedly attached to certain element-receiving means intermediate superior knob-engaging end 19 and element-receiving socket 30. It will be understood that the superior sphere surface functions to support superior boot end 44.

The element-receiving means, as contemplated in the first alternative embodiment, may be defined by a socket-tube assembly. In this regard, it is contemplated that the socket-tube assembly preferably comprises element-receiving socket 30 (as earlier described) and a housing-receiving tube 63 as illustrated and referenced in FIGS. 9-11. Housing-receiving tube 63 preferably comprises a superior tube end 64 as illustrated and referenced in FIGS. 9-11, and 13; an inferior tube end 65 as illustrated and referenced in FIG. 9; a shifter-simulative outer tube surface as generally referenced at 66 in FIGS. 10 and 11; a housing-receiving inner tube surface as generally referenced at 67 in FIG. 11; and a medial housing axis. From an inspection of the noted figures, it will be further understood that boot support sphere 62 preferably comprises a tube-receiving tunnel, the tube-receiving tunnel having a medial tunnel axis, the medial tunnel axis and the polar axis being collinear. Housing-receiving tube 63 thus preferably extends through the tube-receiving tunnel as generally depicted in FIGS. 9 and 11. Inferior tube end 65 is preferably received in element-receiving socket 30 as generally depicted in FIG. 9. Preferably, when inferior tube end 65 is received in element-receiving socket 30, support tube fastening means (as referenced at 68 in FIG. 11) function to set inferior tube end 65 in place so that inferior tube end 65 will not otherwise become removed from element-receiving socket 30. Notably, the medial housing axis is preferably collinear with the medial tunnel axis and the polar axis. Of further note, cartridge-receiving shaft housing 14 extends through housing-receiving tube 63 in medial adjacency to inner tube surface 67 as generally depicted in FIGS. 9 and 11. The socket-tube assembly functions to elevate the boot support means (as defined by the ball support assembly) to a superior position relative to element-receiving socket 30. In this regard, it will be further noted that an alternative (more elevated) junction-concealing boot 27 has been illustrated in FIGS. 9-11 as a means to highlight the various types of boot structure that may be utilized in the present invention.

While the above description contains much specificity, this specificity should not be construed as limitations on the scope of the invention, but rather as an exemplification of the invention. For example, it is believed that the spirit of the present invention discloses boot support means defined by a select boot support assembly. The select boot support assembly may be selected from the group consisting of the washer support assembly and the ball support assembly. As earlier specified, the washer support assembly comprises a washer support clamp and a boot support washer. The ball support assembly comprises a boot support sphere and a socket-tube assembly. Further, the element-receiving means may be defined by select coupling structure, the select coupling structure being selected from the group consisting of the element-receiving socket and the socket-tube assembly. Further, the element-receiving means may be defined by an aperture formed in the superior boot end for removably receiving and holding the inferior housing end. It is further contemplated that boot support means may be defined by the inherent support characteristics of the materials used in the construction of junction-concealing boot 27. In other words, it is contemplated that junction-concealing boot 27 may be self-supportive and thus the boot support means may be defined by such self-supportive characteristic as found in the materials comprising junction-concealing boot 27.

Thus, by way of example, it is contemplated that the present invention essentially discloses a gear shifter pen assembly, the gear shifter pen assembly comprising, in combination, an upper pen-shifter assembly and a lower pen-holding boot assembly. The upper pen-shifter assembly essentially comprises a cartridge-receiving shaft housing and a writing element. The shaft housing essentially comprises a superior housing end, an inferior housing end, a shifter-simulative outer shaft surface, and an element-receiving inner shaft surface. The writing element essentially comprises an ink outlet and an ink-retaining body. The ink-retaining body is received in the shaft housing in medial adjacency to the inner shaft surface. The ink outlet extends from the inner shaft surface to the outer shaft surface adjacent the inferior housing end.

The lower pen-holding boot assembly essentially comprises an inner junction assembly and an outer base assembly. The outer base assembly essentially comprises a junction-concealing boot and a platform assembly. The inner junction assembly essentially comprises element-receiving means and boot support means. The element-receiving means essentially comprises a superior shifter-receiving end and an inferior platform-engaging end. The inferior platform-engaging end is fixedly attached to the platform assembly. The boot support means may be cooperatively associated with the element-receiving means intermediate the superior shifter-receiving end and the inferior platform-engaging end. The junction-concealing boot comprises a superior boot end, an inferior boot end, an inner boot surface, and an outer boot surface. The superior boot end comprises an end-receiving aperture. The boot support means support the superior boot end and the superior shifter-receiving end extends from the inner boot surface to the outer boot surface through the end-receiving aperture.

The platform assembly comprises a superior platform surface and an inferior platform surface. The inferior platform surface is positionable in superior adjacency to a pen assembly-supporting surface. The inferior housing end is removably received by the superior shifter-receiving end. The lower pen-holding boot assembly holds the upper pen-shifter assembly when the superior shifter-receiving end removably receives the inferior housing end. The ink outlet enables a user to write when the inferior housing end is removed from the superior shifter-receiving end.

At its very essence, the present invention teaches a gear shifter pen assembly that comprises an upper pen-shifter assembly and a lower pen-holding boot assembly. The upper pen-shifter assembly comprises a cartridge-receiving shaft housing and a writing element. The shaft housing comprises a superior housing end, an inferior housing end, and an element-receiving inner shaft surface. The writing element comprises an ink outlet and an ink-retaining body. The ink-retaining body is received in the shaft housing in medial adjacency to the inner shaft surface and the ink outlet extends from the inner shaft surface to the outer shaft surface adjacent the inferior housing end. The lower pen-holding boot assembly comprises element-receiving means, boot support means, and an outer base assembly. The outer base assembly comprises a shifter boot comprising a superior boot end, an inferior boot end, an inner boot surface, and an outer boot surface. The element-receiving means is cooperatively associated with the superior boot end for removably receiving the inferior housing end. The boot support means support the superior boot end in an elevated state relative to the inferior boot end. The inferior housing end is thus removably receivable by the element-receiving means. The lower pen-holding boot assembly holds the upper pen-shifter assembly when the element-receiving means removably receives the inferior housing end and the ink outlet enabling a user to write when the inferior housing end is removed from the element-receiving means.

Further, it is contemplated that the gear shifter pen assembly may essentially comprise, in combination, a shifter handle, a cartridge-receiving shaft housing, and a writing element. The resulting assembly, as earlier specified, resembles the upper portion of a traditional gear shifter assemblage and is itself believed to be visually indicative of a gear shifter pen assembly. Accordingly, although the invention has been described by reference to a preferred embodiment, and a first alternative embodiment, it is not intended that the novel assembly or apparatus be limited thereby, but that modifications thereof are intended to be included as falling within the broad scope and spirit of the foregoing disclosure, the following claims and the appended drawings.

We claim:

1. A gear shifter pen assembly, the gear shifter pen assembly comprising, in combination:
an upper pen-shifter assembly, the upper pen-shifter assembly comprising a shifter handle, a cartridge-receiving shaft housing, and a writing element, the shifter handle comprising a superior hand-receiving surface and an inferior shaft-engaging region, the cartridge-receiving shaft housing comprising a superior handle-engaging end, an inferior socket-engaging end, an shaft-simulative outer shaft surface, and an element-receiving inner shaft surface, the writing element comprising an ink outlet and an ink-retaining body, the ink-retaining body being received in the cartridge-receiving shaft housing in medial adjacency to the inner shaft surface, the ink outlet extending from the inner shaft surface to the outer shaft surface adjacent the inferior socket-engaging end, the inferior shaft-engaging region being removably attached to the superior handle-engaging end;
a lower pen-holding boot assembly, the lower pen-holding boot assembly comprising an inner junction assembly and an outer base assembly, the outer base assembly comprising a flexible junction-concealing boot and a platform assembly, the inner junction assembly comprising a universal joint, an element-receiving socket, a universal mount, a universal clamp, a washer support clamp, and a boot support washer, the universal joint comprising a superior socket-engaging end, an inferior mount end, and triaxial orientation means, the triaxial orientation means being spatially located intermediate the superior socket-engaging end and the inferior mount end, the element-receiving socket comprising a superior shifter-receiving end, an inferior joint-engaging end, and an outer socket surface, the inferior joint-engaging end being fixedly attached to the superior socket-engaging end, the universal clamp mounting the inferior mount end to the universal mount, the universal mount being fixedly attached to the platform assembly, the washer support clamp being mounted to the outer socket surface intermediate the superior shifter-receiving end and the inferior joint-engaging end, the boot support washer comprising a socket-receiving aperture, the socket-receiving aperture receiving the element-receiving socket, the washer support clamp supporting the boot support washer intermediate the superior shifter-receiving end and the inferior joint-engaging end, the junction-concealing boot having a superior boot end, an inferior boot end, an inner boot surface, and an outer boot surface, the superior boot end comprising a socket-receiving aperture, the boot support washer supporting the superior boot end, the superior shifter-receiving end extending from the inner boot surface to the outer boot surface through the socket-receiving aperture, the platform assembly comprising a superior platform surface and an inferior platform surface, the inferior boot end engaging the superior platform surface, the inner boot surface defining a junction-assembly-receiving volume, the inferior platform surface being positionable in superior adjacency to a pen assembly-supporting surface, the inferior socket-engaging end being removably received in the superior shifter-receiving end, the triaxial orientation means enabling a user to selectively position the upper pen-shifter assembly when the superior shifter-receiving end removably receives the inferior socket-engaging end, the ink outlet enabling the user to write when the inferior socket-engaging end is removed from the superior shifter-receiving end.

2. The gear shifter pen assembly of claim 1 wherein the platform assembly comprises a boot plate, the boot plate being attached to the superior platform surface adjacent the inferior boot end.

3. The gear shifter pen assembly of claim 1 wherein the inner junction assembly comprises movement-restricting means, the movement restricting means being cooperatively associated with the universal joint for restricting movement thereof.

4. The gear shifter pen assembly of claim 3 wherein the movement-restricting means is defined by a joint-surrounding sleeve, the joint-surrounding sleeve surrounding the triaxial orientation means, the joint-surrounding sleeve having positionable flexibility, the positionable flexibility for enhancing the selective positionability of the upper pen-shifter assembly.

5. The gear shifter pen assembly of claim 1 wherein the upper pen-shifter assembly comprises cartridge-setting means, the cartridge-setting means for preventing movement of the ink-retaining body within the cartridge-receiving shaft housing.

6. The gear shifter pen assembly of claim 1 wherein the platform assembly comprises at least one utility tray, the utility tray being located adjacent the superior platform surface, the utility tray enabling the user to retain articles adjacent the lower pen-holding boot assembly.

7. The gear shifter pen assembly of claim 1 wherein the inferior platform surface comprises a plurality of base-supporting feet, the base-supporting feet for preventing movement of the platform assembly when the user selectively positions the upper pen-shifter assembly.

8. The gear shifter pen assembly of claim 1 wherein the platform assembly comprises dashboard visual effect gadgetry, the dashboard visual effect gadgetry comprising select dash panel accessories, the select dash panel accessories being selected from the group comprising gauges and clocks.

9. A gear shifter pen assembly, the gear shifter pen assembly comprising, in combination:
an upper pen-shifter assembly, the upper pen-shifter assembly comprising a shifter handle, a cartridge-receiving shaft housing, and a writing element, the shifter handle comprising a superior hand-receiving surface and an inferior shaft-engaging region, the cartridge-receiving shaft housing comprising a superior handle-engaging end, an inferior socket-engaging end, an outer shaft surface, and an element-receiving inner shaft surface, the writing element comprising an ink outlet and an ink-retaining body, the ink-retaining body being received in the cartridge-receiving shaft housing in medial adjacency to the inner shaft surface, the ink outlet extending from the inner shaft surface to the outer shaft surface adjacent the inferior socket-engaging end, the inferior shaft-engaging region being removably attached to the superior handle-engaging end;
a lower pen-holding boot assembly, the lower pen-holding boot assembly comprising an inner junction assembly and an outer base assembly, the outer base assembly comprising a flexible junction-concealing boot and a platform assembly, the inner junction assembly comprising a universal joint, a universal mount, a universal clamp, element-receiving means, and boot support means, the universal joint comprising a superior joint end, an inferior joint end, and triaxial orientation means, the triaxial orientation means being spatially located intermediate the superior joint end and the inferior joint end, the element-receiving means comprising a superior shifter-receiving end, an inferior joint-engaging end, and an outer socket surface, the inferior joint-engaging end being fixedly attached to the superior socket-engaging end, the universal clamp mounting the inferior mount end to the universal mount, the universal mount being fixedly attached to the platform assembly, the boot support means being cooperatively associated with the outer socket surface intermediate the superior shifter-receiving end and the inferior joint-engaging end, the junction-concealing boot comprising a superior boot end, an inferior boot end, an inner boot surface, and an outer boot surface, the superior boot end comprising a socket-receiving aperture, the boot support means supporting the superior boot end, the superior shifter-receiving end extending from the inner boot surface to the outer boot surface through the socket-receiving aperture, the platform assembly comprising a superior platform surface and an inferior platform surface, the. inferior boot end engaging the superior platform surface, the inner boot surface defining a junction-assembly-receiving volume, the inferior platform surface being positionable in superior adjacency to a pen assembly-supporting surface, the inferior socket-engaging end being removably received in the superior shifter-receiving end, the triaxial orientation means enabling a user to selectively position the upper pen-shifter assembly when the superior shifter-receiving end removably receives the inferior socket-engaging end, the ink outlet enabling the user to write when the inferior socket-engaging end is removed from the superior shifter-receiving end.

10. The gear shifter pen assembly of claim 9 wherein the boot support means is defined by a select boot support assembly, the select boot support assembly being selected from the group consisting of a washer support assembly and a ball support assembly, the washer support assembly comprising a washer support clamp and a boot support washer, the washer support clamp being mounted to the outer socket surface intermediate the superior shifter-receiving end and the inferior joint-engaging end, the boot support washer comprising a socket-receiving aperture, the socket-receiving aperture receiving the element-receiving means, the washer support clamp supporting the boot support washer, the boot support washer thus being positioned intermediate the superior shifter-receiving end and the inferior joint-engaging end, the boot support washer supporting the superior boot end, the ball support assembly comprising a boot support sphere, the boot support sphere comprising a superior sphere surface, a substantially vertical polar axis, a north pole, and a south pole, the polar axis extending from the north pole to the south pole, the boot support sphere being fixedly attached to the element-receiving means intermediate the superior shifter-receiving end and the inferior joint-engaging end, the superior sphere surface supporting the superior boot end.

11. The gear shifter pen assembly of claim 10 wherein the element-receiving means is defined by select coupling structure, the select coupling structure being selected from the group consisting of an element-receiving socket and a socket-tube assembly, the socket-tube assembly comprising the element-receiving socket and a housing-receiving tube, the housing-receiving tube comprising a superior tube end, an inferior tube end, an outer tube surface, a housing-receiving inner tube surface, and a medial housing axis, the boot support sphere comprising a tube-receiving tunnel, the tube-receiving tunnel comprising a medial tunnel axis, the medial tunnel axis and the polar axis being collinear, the housing-receiving tube extending through the tube-receiving tunnel, the inferior tube end being received in the element-receiving socket, the medial housing axis being collinear with the medial tunnel axis and the polar axis, the cartridge-receiving shaft housing extending through the housing-receiving tube in medial adjacency to the inner tube surface.

12. The gear shifter pen assembly of claim 9 wherein the platform assembly comprises a boot plate, the boot plate being attached to the superior platform surface adjacent the inferior boot end.

13. The gear shifter pen assembly of claim 9 wherein the inferior platform surface comprises a plurality of base-supporting feet, the base-supporting feet for preventing movement of the platform assembly when the user selectively positions the upper pen-shifter assembly.

14. The gear shifter pen assembly of claim 9 wherein the inner junction assembly comprises movement-restricting means, the movement restricting means being cooperatively associated with the universal joint for restricting movement thereof.

15. The gear shifter pen assembly of claim 9 wherein the platform assembly comprises at least one utility tray, the utility tray being located adjacent superior platform surface, the utility tray enabling the user to retain articles adjacent the lower pen-holding boot assembly.

16. The gear shifter pen assembly of claim 9 wherein the platform assembly comprises dashboard visual effect gadgetry, the dashboard visual effect gadgetry comprising select dash panel accessories, the select dash panel accessories being selected from the group comprising gauges and clocks.

17. A gear shifter pen assembly, the gear shifter pen assembly comprising, in combination:
an upper pen-shifter assembly, the upper pen-shifter assembly comprising a cartridge-receiving shaft housing and a writing element, the shaft housing comprising a superior housing end, an inferior housing end, and an element-receiving inner shaft surface, the writing element comprising an ink outlet and an ink-retaining body, the ink-retaining body being received in the shaft housing in medial adjacency to the inner shaft surface, the ink outlet extending from the inner shaft surface to the outer shaft surface adjacent the inferior housing end;
a lower pen-holding boot assembly, the lower pen-holding boot assembly comprising an inner junction assembly and an outer base assembly, the outer base assembly comprising a junction-concealing boot and a platform assembly, the inner junction assembly comprising element-receiving means and boot support means, the element-receiving means comprising a superior shifter-receiving end and an inferior platform-engaging end, the inferior platform-engaging end being fixedly attached to the platform assembly, the boot support means being cooperatively associated with the element-receiving means intermediate the superior shifter-receiving end and the inferior platform-engaging end, the junction-concealing boot comprising a superior boot end, an inferior boot end, an inner boot surface, and an outer boot surface, the superior boot end comprising an end-receiving aperture, the boot support means supporting the superior boot end, the superior shifter-receiving end extending from the inner boot surface to the outer boot surface through the end-receiving aperture, the platform assembly comprising a superior platform surface and an inferior platform surface, the inner boot surface defining a junction-assembly-receiving volume, the inferior platform surface being positionable in superior adjacency to a pen assembly-supporting surface, the inferior housing end being removably received by the superior shifter-receiving end, the lower pen-holding boot assembly holding the upper pen-shifter assembly when the superior shifter-receiving end removably receives the inferior housing end, the ink outlet enabling a user to write when the inferior housing end is removed from the superior shifter-receiving end.

18. The gear shifter pen assembly of claim 17 wherein the upper pen-shifter assembly comprises a shifter handle, the shifter handle comprising a superior hand-receiving surface and an inferior shaft-engaging region, the inferior shaft-engaging region being removably attached to the superior housing end.

19. The gear shifter pen assembly of claim 17 wherein the element-receiving means comprises triaxial orientation means, the triaxial orientation means being spatially located intermediate the superior shifter-receiving end and the inferior platform-engaging end, the triaxial orientation means enabling a user to selectively position the upper pen-shifter assembly when the superior shifter-receiving end removably receives the inferior housing end.

20. The gear shifter pen assembly of claim 19 wherein the inner junction assembly comprises movement-restricting means, the movement restricting means being cooperatively associated with the triaxial orientation means for restricting movement thereof.

21. The gear shifter pen assembly of claim 17 wherein the inferior platform surface comprises a plurality of base-supporting feet, the base-supporting feet for preventing movement of the platform assembly when the user selectively positions the upper pen-shifter assembly.

22. The gear shifter pen assembly of claim 17 wherein the platform assembly comprises at least one utility tray, the utility tray being located adjacent the superior platform surface, the utility tray enabling the user to retain articles adjacent the lower pen-holding boot assembly.

23. The gear shifter pen assembly of claim 17 wherein the platform assembly comprises dashboard gadgetry, the dashboard gadgetry comprising select accessories, the select accessories being selected from the group comprising gauges and clocks.

24. A gear shifter pen assembly, the gear shifter pen assembly comprising, in combination:
an upper pen-shifter assembly, the upper pen-shifter assembly comprising a cartridge-receiving shaft housing and a writing element, the shaft housing comprising a superior housing end, an inferior housing end, an outer shaft surface, and an element-receiving inner shaft surface, the writing element comprising an ink outlet and an ink-retaining body, the ink-retaining body being received in the shaft housing in medial adjacency to the inner shaft surface, the ink outlet extending from the inner shaft surface to the outer shaft surface adjacent the inferior housing end;
a lower pen-holding boot assembly, the lower pen-holding boot assembly comprising element-receiving means, boot support means, and an outer base assembly, the outer base assembly comprising a shifter boot, the shifter boot comprising a superior boot end, an inferior boot end, an inner boot surface, and an outer boot surface, the element-receiving means being cooperatively associated with the superior boot end for removably receiving the inferior housing end, the boot support means supporting the superior boot end in an elevated state relative to the inferior boot end, the inferior housing end being removably received by the element-receiving means, the lower pen-holding boot assembly holding the upper pen-shifter assembly when the element-receiving means removably receives the inferior housing end, the ink outlet enabling a user to write when the inferior housing end is removed from the element-receiving means.

25. The gear shifter pen assembly of claim 24 wherein the outer base assembly comprises a support platform, the inferior boot end engaging the support platform.

26. The gear shifter pen assembly of claim 24 wherein the upper pen-shifter assembly comprises a shifter handle, the shifter handle comprising a superior hand-receiving surface and an inferior shaft-engaging region, the inferior shaft-engaging region being removably attached to the superior housing end.

27. A gear shifter pen assembly, the gear shifter pen assembly comprising, in combination, a shifter handle, a cartridge-receiving shaft housing, and a writing element, the shifter handle comprising a superior hand-receiving surface and an inferior shaft-engaging region, the cartridge-receiving shaft housing comprising a superior housing end, an inferior housing end, an outer shaft surface, and an element-receiving inner shaft surface, the writing element comprising an ink outlet and an ink-retaining body, the ink-retaining body being received in the cartridge-receiving shaft housing in medial adjacency to the inner shaft surface, the ink outlet extending from the inner shaft surface to the outer shaft surface adjacent the inferior housing end, the inferior shaft-engaging region being removably attached to the superior handle-engaging end, the gear shifter pen assembly visually resembling a gear shifter.
